(19) United States
(12) Patent Application Publication
(10) Pub. No.: US 2002/0169592 A1
(43) Pub. Date: Nov. 14, 2002

(54) Open environment for real-time multilingual communication

(76) Inventor: Sergey Khachatur Aityan, Huntington Beach, CA (US)

Correspondence Address: Paul A. Maltseff, 5106 149th PL SW, Edmonds, WA, 98026, US

(21) Appl. No.: 10/143,184

(22) Filed: May 10, 2002

Related U.S. Application Data
(60) Provisional application No. 60/290,224, filed on May 11, 2001.

(51) Int. Cl. G06F 17/28

(52) U.S. Cl. 704/2

(57) ABSTRACT

An open environment for a real-time multilingual communication environment for text-based and voice conversations in a variety of different languages and/or for multilingual machine-generated or machine-carried text exchanges in a variety of languages. The users send their messages in their own spoken languages and the recipients receive in real-time the messages translated into their spoken languages. The open environment provides links to a variety of the online real-time translation services available on the Internet or on other network and controls real-time translation by selecting the best translation services for translations, which are specific to the theme of the communication session and to the number of languages needed for translation in the session. The users are communicating in different natural languages with the real-time translation to the language designated by each user. An automated and/or manual selection of the on-line language translation services is provided and the internal quality rating for each translation service is built and maintained to provide the best quality of the translation for multilingual communication. A variety of on-line translation services can be used in the communication session to assure the best quality of translation. The translation services can be switched during the session.

### CROSS REFERENCE TO RELATED APPLICATIONS

This application claims priority to the U.S. provisional application Ser. No. 60/290,224 filed May 11, 2001.

### BACKGROUND OF THE INVENTION

1. Field of the Invention

The present invention generally relates to real-time online written and/or verbal language translations, online chat systems, net conferences, and real-time

The present invention generally relates to real-time online written and/or verbal language translations, online chat systems, net conferences, and real-time collaborative systems and more particularly, is concerned with a real-time multilingual communication environment for real-time written and/or verbal communications of individuals speaking in different languages and real-time multilingual machine generated or carried text exchanges in a variety of human natural languages.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility.

2. Description of Related Art

A general concept of a network based natural language translation has been discussed in a number of U.S. patents and publications. Natural language translation engines currently are available on Internet for a real-time translation of written text from one language into another. There are several commercially available engines distributed and supported by AltaVista Company, PROject MT Ltd, Softissimo, Smart Link Corporation, etc. These engines provide translations for a variety of natural languages. However, all existing natural language translation engines are limited by number of languages and/or by number of translation themes they support. At the same time it should be pointed out that different translation engines provide different quality of a translation for different languages and themes.

On-line communication tools such as online chats, net conferences and real-time collaborative systems provide convenient real-time online communication environments. Those environments are mostly monolingual. It is quite obvious that such communication tools integrated or linked with any specific language translation engine would experience the same language translation problems as specific translation engines typically experience. Therefore, a need exists for a more efficient approach to implement and create an open real-time multilingual environment capable to seamlessly integrate together communication online chats, net conferences and real-time collaborative systems without compromising a quality of a multilingual translation. Such need is permanently growing with increasing globalization of human society and world economy.

A general idea of network based language translation was disclosed by Goldberg, et al. (U.S. Pat. No. 6,161,082, hereinafter “Goldberg”), and Trudeau (U.S. Pat. No. 5,987,401, hereinafter “Trudeau”). Goldberg disclosed a network based language translation system with language translation software installed on the network. A user communication device that is interconnected to the network is utilized to communicate with the network. The user communication device both inputs text and/or spoken communications into the network and receives text and/or spoken communications from the network. The network is able to receive communication inputs from multiple users in multiple languages and translate and transmit output communications to those users in languages designated by the users. However the Goldberg teaching is limited to a single translation engine and does not suggests an employment of multiple translation engines simultaneously.

Trudeau disclosed a real-time language translation technique for text-based conversations. The messages forming the text-based conversation amongst a plurality of participants to the conversation are translated in real-time either from a user language to a conversation language of the conversation, or from the conversation language to the user language. The result is that the user is able to seamlessly converse in a text-based conversation (in the conversation language) using a language other than the conversation language. The invention is particularly advantageous for on-line text-based conversations, wherein users of on-line text-based conversations are able to seamlessly converse with each other in different languages. It should be mentioned however that Trudeau basically tackled only a translation technique rather than a multi-engine translation network.

Both above-identified patents represent approaches, which are limited in a selection of translation services available on the network. These limitations do not allow to achieve a high quality multilingual communication due to limitations of any specific language translation engine that operates alone.

Automatic language translation technique for use in a telecommunications network was disclosed Eslambolchi, et al. (U.S. Pat. No. 5,875,422, hereinafter “Eslambolchi”). It suggested a telecommunications network providing a connection between a calling and called parties and advantageously translating information generated by the calling and called parties in accordance with language preferences entered by the called and calling parties, respectively. Eslamboichi unveiled a speech translation technique, which is identified as “word for word translation”. The word-to-word translation presents a serious limitation of the approach, which can be only used for translating simple instructions.

An automated language translation is one of the focus points in multilingual communication. A key requirement to an automated translation is to provide a high degree of accuracy in translation to make it practically usable. This problem has been addressed by Christy (U.S. Pat. No. 5,884,247, hereinafter “Christy”), Brown, et al. (U.S. Pat. No. 5,805,832, hereinafter “Brown”), Liddy, et al. (U.S. Pat. No. 6,006,221 and U.S. Pat. No. 5,963,940, hereinafter “Liddy '221” and “Liddy '940” respectfully) and Chong, et al. (U.S. Pat. No. 5,497,319, hereinafter “Chong”).

Christy disclosed a specific method and apparatus for automated language translation engine. Language translation is accomplished by representing naturallanguage sentences in accordance with a constrained grammar and vocabulary structured to permit direct substitution of linguistic units in one language for corresponding linguistic units in another language. The vocabulary is represented in a series of physically or logically distinct databases, each containing entries representing a form class as defined in the grammar. Translation involves direct lookup between the entries of a reference sentence and the corresponding entries in one or more target languages. Christy limited the scope of the translation to a single engine and did not address application of multiple engines or a network of translation engines.

Brown disclosed a system for a parametric text-to-text language translation, capable to translate a text from a first source language into a second target language. The system assigns probabilities or scores to various target-language translations and then displays or makes otherwise available the highest scoring translations. The source text is first transduced into one or more intermediate structural representations. From these intermediate source structures a set of intermediate target-structure hypotheses is generated. These hypotheses are scored by two different models: a language model which assigns a probability or score to an intermediate target structure, and a translation model which assigns a probability or score to the event that an intermediate target structure is translated into an intermediate source structure. Scores from the translation model and language model are combined into a combined score for each intermediate target-structure hypothesis. Finally, a set of target-text hypotheses is produced by transducing the highest scoring target-structure hypotheses into portions of text in the target language. The system can either run in batch mode, in which case it translates source-language text into a target language without human assistance, or it can function as an aid to a human translator. When functioning as an aid to a human translator, the human may simply select from the various translation hypotheses provided by the system, or he may optionally provide hints or constraints on how to perform one or more of the stages of source transduction, hypothesis generation and target transduction. Brown is limiting his teaching to a translation technique of a single translation engine and did not address application of multiple engines or a network of translation engines.

Liddy '221 disclosed a multilingual document retrieval system and method using semantic vector matching. A document retrieval system where a user can enter a query, including a natural language query, in a desired one of a plurality of supported languages, and retrieve documents from a database that includes documents in at least one other language of the plurality of supported languages. The user need not have any knowledge of the other languages. Each document in the database is subjected to a set of processing steps to generate a language-independent conceptual representation of the subject content of the document. This is normally done before the query is entered. The query is also subjected to a (possibly different) set of processing steps to generate a language-independent conceptual representation of the subject content of the query. The documents and queries can also be subjected to additional analysis to provide additional term-based representations, such as the extraction of information-rich terms and phrases (such as proper nouns). Documents are matched to queries based on the conceptual-level contents of the document and query, and, optionally, on the basis of the term-based representation. The query's representation is then compared to each document's representation to generate a measure of relevance of the document to the query. Thus, Liddy '221 disclosed a translation technique and technique of a natural language retrieval system, but did not discussed the integration of such techniques in a network of translation engines.

Liddy '940 disclosed a natural language information retrieval system and method. Techniques for generating sophisticated representations of the contents of both queries and documents in a retrieval system by using natural language processing techniques to represent, index, and retrieve texts at the multiple levels (e.g., the morphological, lexical, syntactic, semantic, discourse, and pragmatic levels) at which humans construe meaning in writing. The user enters a query and the system processes the query to generate an alternative representation, which includes conceptual-level abstraction and representations based on complex nominals, proper nouns, single terms, text structure, and logical make-up of the query, including mandatory terms. After processing the query, the system displays query information to the user, indicating the system's interpretation and representation of the content of the query. The user is then given an opportunity to provide input, in response to which the system modifies the alternative representation of the query. Once the user has provided desired input, the possibly modified representation of the query is matched to the relevant document database, and measures of relevance generated for the documents. A set of documents is presented to the user, who is given an opportunity to select some or all of the documents, typically on the basis of such documents being of particular relevance. The user then initiates the generation of a query representation based on the alternative representations of the selected document(s). And again, as it was pointed out earlier, Liddy 940 disclosed a translation technique and technique of a natural language retrieval system, but did not discussed the integration of such techniques in a network of translation engines.

Chong disclosed a machine translation and telecommunications system. A machine translation and telecommunications system automatically translates input text in a source language to output text in a target language using a dictionary database containing core language dictionaries for general words, a plurality of sublanguage dictionaries for specialized words of different domains or user groups, and a plurality of user dictionaries for individualized words used by different users. The system includes a receiving interface for receiving input from a sender, in the form of electronic text, facsimile (graphics) input, or page image data, and an output module for sending translated output text to any designated recipient(s). The input text is accompanied by a cover page or header identifying the sender, one or more recipients, their addresses, the source/target languages of the text, any sublanguage(s) applicable to the input text, and any formatting requirements for the output text. The system uses the cover page or header data to select the core language, sublanguage, and/or user dictionaries to be used for translation processing, to format the translated output text, and to send the output to the recipient(s) at the designated address(es). The dictionary database can cumulate and evolve over time by adding new words as scratch entries to the user dictionaries and, through the use of dictionary maintenance utilities, by updating and/or moving the scratch entries to higher-level subdomain, domain, or even core dictionaries as their usage gains currency. It would be correct to state that Chong limited his disclosure to a concept of an automated translation by using dictionaries and did not address the issues related to a network of translation engines Christy, Brown, Liddy '221, Liddy '940, and Chong made a significant contribution to the technique of automated translation of natural languages. However, no single technique can provide accurate natural language translation. A comprehensive and accurate solution should represent a diversified combination of many methods and techniques.

Sharman, et. al. (U.S. Pat. No. 6,100,882, hereinafter “Sharman”) disclosed speech recognition and its conversion to text with regard to monolingual speech teleconferencing to produce minutes for the conference. A computer workstation supports speech recognition software and conferencing software, and is involved in an audio conference with one or more other workstations. Speech from the user at that workstation is transmitted to the other workstation(s), and also converted into text by the speech recognition software. The conferencing software then transmits the text to the other workstation(s). Likewise, the conferencing software also receives the text equivalent of spoken contributions from the other workstation(s). This received text, together with the locally generated text, is stored in a text file so as to produce a set of minutes for the audio conference. However, Sharman did not address issues related to a translation quality evaluation and limited just to a monolingual communication.

Boguraev (U.S. Pat. No. 6,212,494, hereinafter “Boguraev”) disclosed a method for extracting knowledge from online documentation and creating a glossary, index, help database or the like. A method involving computer-mediated linguistic analysis of online technical documentation to extract and catalog from the documentation knowledge essential to, for example, creating a online help database useful in providing online assistance to users in performing a task. The method comprises stripping markup tags from the documentation, linguistically analyzing and annotating the text, including the steps of morphologically and lexically analyzing the text, disambiguating between possible parts-of-speech for each word, and syntactically analyzing and labeling each word. The method further comprises the steps of combining the linguistically analyzed, annotated, and labeled text and previously stripped markup information into a merged file, mining the merged file for domain knowledge, including the steps of identifying and creating a list of technical terminology, mining the merged file for manifestations of domain primitives and maintaining a list of manifestations of such domain primitives in an observations file, analyzing the discourse context of each sentence or phrase in the merged file, analyzing the frequency of manifestations of domain primitives in the observations file to determine those that are important, expanding the list of key terms by searching for terms sanctioned by a domain primitive deemed important in the previous step, and searching the merged file for larger relations by searching for particular lexicosyntactic patterns involving key terms and manifestations of domain primitives previously identified. The method further comprises the steps of structuring the knowledge thus mined and building a domain catalog.

Carbonell et al. (U.S. Pat. No. 6,139,201, hereinafter “Carbinell”) disclosed an integrated authoring and translation system. A system of integrated, computer-based processes for monolingual information development and multilingual translation is presented. An interactive text editor enforcing lexical and grammatical constraints on a natural language subset used to create their text, which they help disambiguate to ensure translatability. The resulting translatable source language text undergoes machine translation into any one of a set of target languages, which do not require an additional editing.

Boguraev and Carbonell represent a further improvement in the technique of automated translation of natural languages. However the disclosed methods are limited to linguistic and morphological analysis of the text.

### SUMMARY OF THE INVENTION

The present invention provides an open real-time multilingual environment to overcome deficiencies of the prior art. The invention utilizes real-time language translation capabilities of the available language translation engines and provides intelligent control and management of the translation sources to ensure the best quality of the multilingual communication. In one embodiment the invention is described as a multilingual network based translation system with online users connected to the system through Internet or other networks. Every user has his/her preferred language and can change the preferred language before or during the session. The server builds a list of the languages for a session along with the session theme and other attributes being used for the session. The server identifies the best translation services for translation in the session. The best translation service is selected from the list of all available online translation services (engines) by its rating of the translation quality for the specific theme and the specific pair of language. Different translation services (engines) can be used for translation into different languages in a multi-user session.

Every user in the communication session has a convenient multilingual user interface to enter a written or verbal message in the user preferred language. Every message sent by a user is forwarded by the server-based Control Center to the online translation service that provides a best translation to the preferred language of the recipient. The translated message is forwarded to the recipient party.

### BRIEF DESCRIPTION OF THE DRAWINGS

The numerous objects and advantages of the present invention may be better understood by reference to the accompanying drawings in which:

FIG. 1 is a basic schematic diagram of contemplated system architecture

FIG. 2 shows language translation paths from a message-sending user through Control Center to the selected service and further to the message recipient.

FIG. 3 shows the open multilingual communication environment internal schema, which illustrates that the online translation services itself might be considered as external services for the invention.

FIG. 4 shows the open multilingual communication environment internal schema with distributed Control Centers communicating over network.

FIG. 5 shows the open multilingual communication environment schema with distributed Control Centers communicating through specialized connections and interfaces.

FIG. 6 shows the open multilingual communication environment schema with distributed Control Centers communicating over network and through specialized connection and interfaces

FIG. 7 shows the open multilingual communication environment schema with distributed Control Centers communicating over network and through specialized connection and interfaces

FIG. 8 shows the open multilingual communication environment schema and Message Translation Paths with distributed Control Centers and multiple Translation Services and Embedded Translation Engines connected over network or through specialized connections and interfaces

FIG. 9 shows a diagram of Control Center functionality. The single or distributed Control Center can reside on a server or any other computer.

FIG. 10 is a diagram of a message path for users that are communicating in the same language.

FIG. 11 is a diagram of a message path for users with communicating in different languages with translation performed by one of the available online translation services

FIG. 12 is a diagram that shows the components of Control Center for text-based communication

FIG. 13 is a diagram that shows the components of Control Center for text-based communication

FIG. 14 is a block diagram of an embodiment of a translation service rating mechanism

FIG. 15 is an example of the implementation of the translation services selection for a given <theme, language 1, language 2>combination by the best rating among matching translation services

### DETAILED DESCRIPTION

Embodiments of the invention are discussed below with reference to the drawings. However, those skilled in the art will readily appreciate that the detailed description given herein with respect to these figures is for explanatory purposes as the invention extends beyond these limited embodiments.

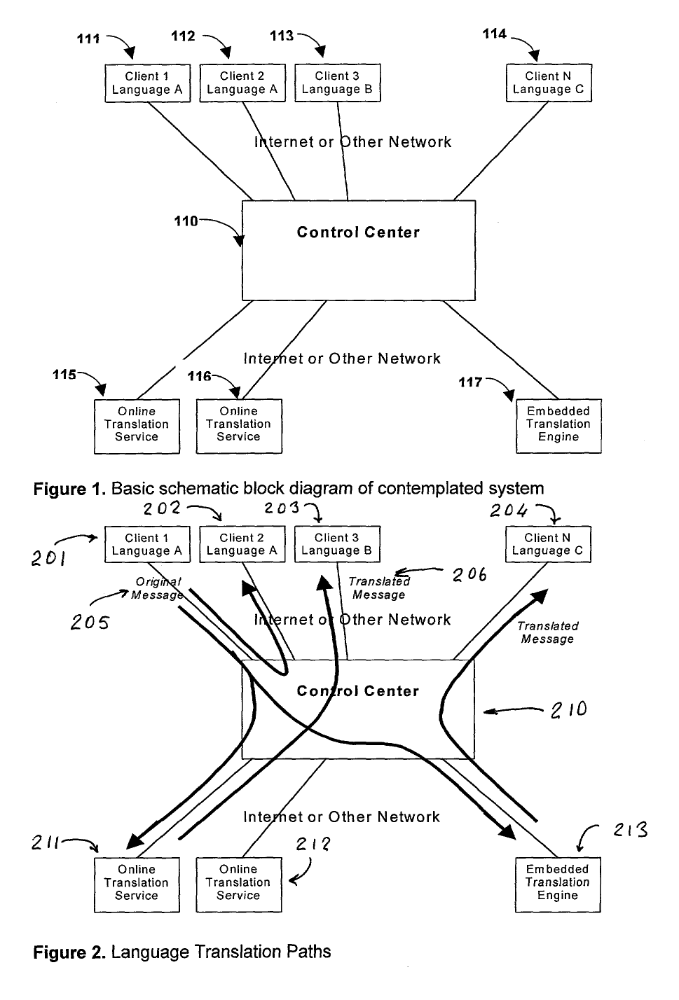

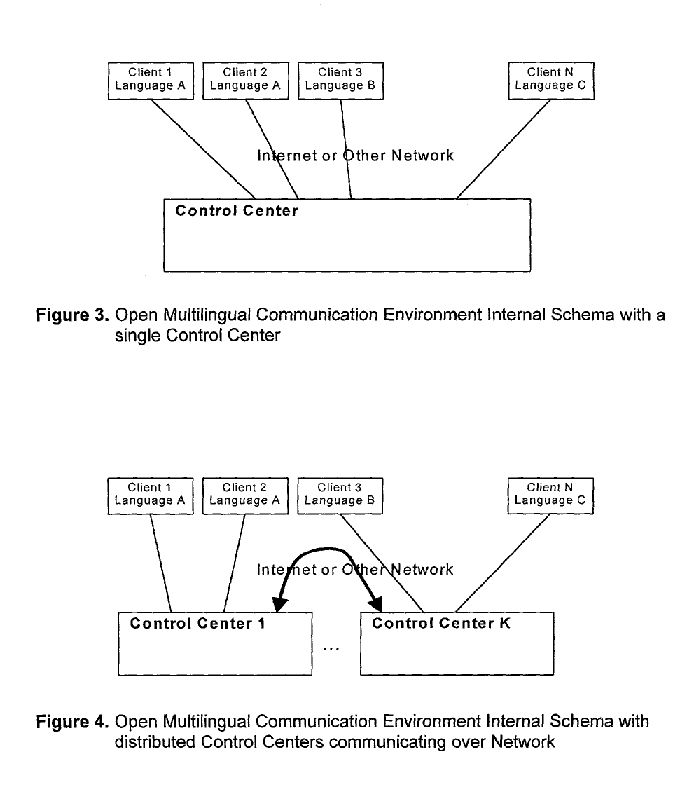

The invention relates to an open environment for real-time multilingual communication for text-based and voice conversations in a variety of different languages and/or for multilingual machine-generated or machine-carried text exchanges in a variety of languages. The general block diagram of the contemplated system architecture is represented on FIG. 1.

A communication session consists of series of text-based and/or voice messages 205, 206 sent and received by the clients 201-204 of the communication session as shown in FIG. 2. The communication session is controlled by a Control Center 210, which may be implemented as a server. A variety of third-party online translation services 211, 212 as well as several embedded translation engines 213 can be used to ensure the best translation for the particular languages and particular communication theme.

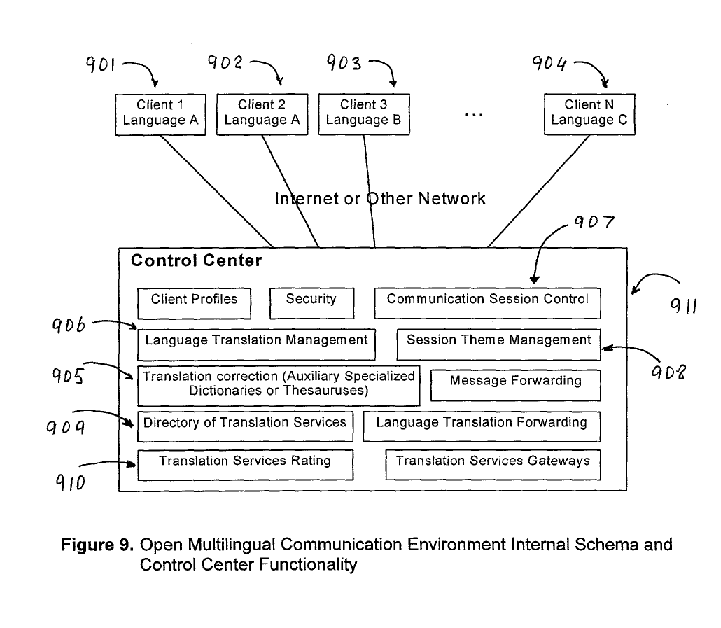

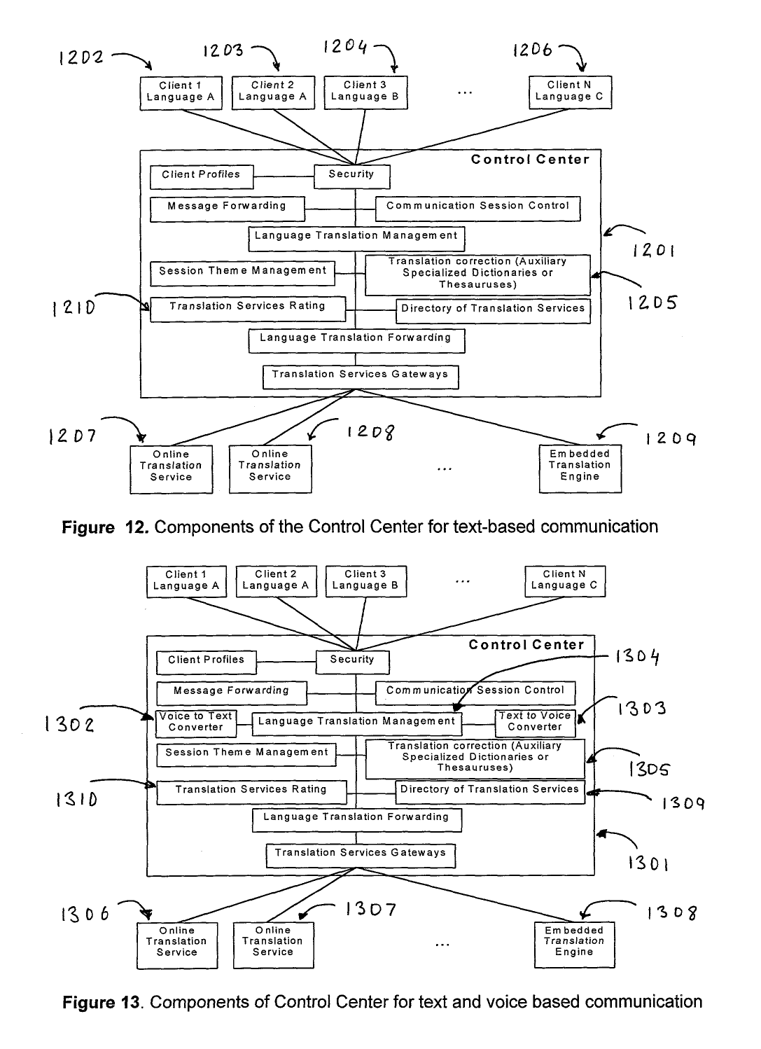

Build-in auxiliary specialized dictionaries or thesauruses 905, 1205, 1305 can be used to improve translations for some specialized themes, see FIG. 9, FIG. 12, and FIG. 13. Such auxiliary specialized dictionaries or thesauruses can be

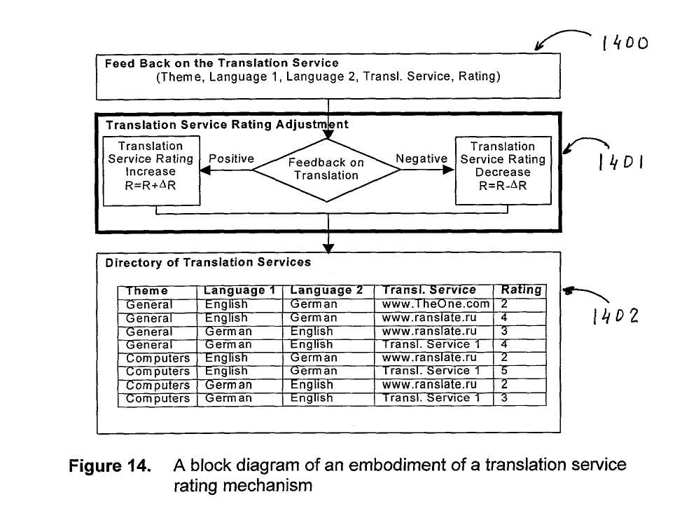

Build-in auxiliary specialized dictionaries or thesauruses 905, 1205, 1305 can be used to improve translations for some specialized themes, see FIG. 9, FIG. 12, and FIG. 13. Such auxiliary specialized dictionaries or thesauruses can be static or have dynamically self-learning capabilities. In addition the translation services rating modules or subsystems 910, 1210, and 1310 rank a translation quality for each given ordered pair of languages and communication themes. The ranking may be supported by dynamic rating mechanism comprising such modules as Feed Back on the Translation Service 1400 and Translation Service Rating Adjustment 1401 as shown in FIG. 14. The rating is attributed to a translation service for a given combination <theme, language 1, language 2>. The rating of the translation service for the given combination <theme, language 1, language 2>increases, if the feedback on the translation quality is positive, and decreases, if the feedback is negative. In case of failure of one of the translation services, translation can be done by the next available translation service qualified for this particular ordered pair of languages from/to and the communication theme.

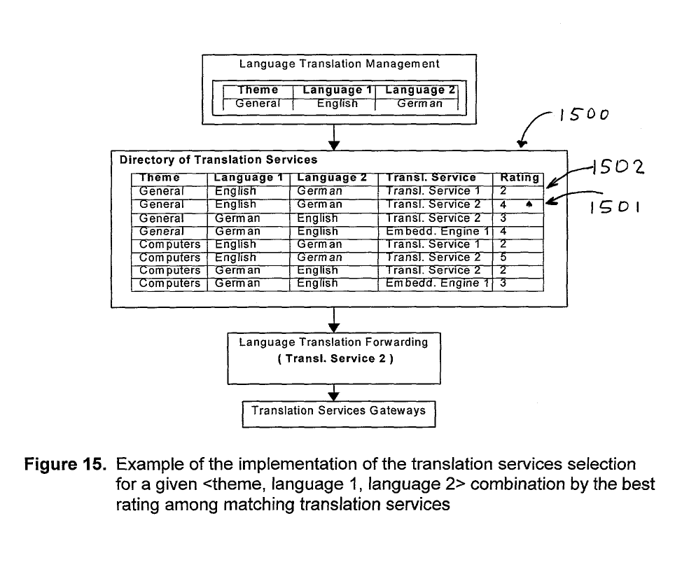

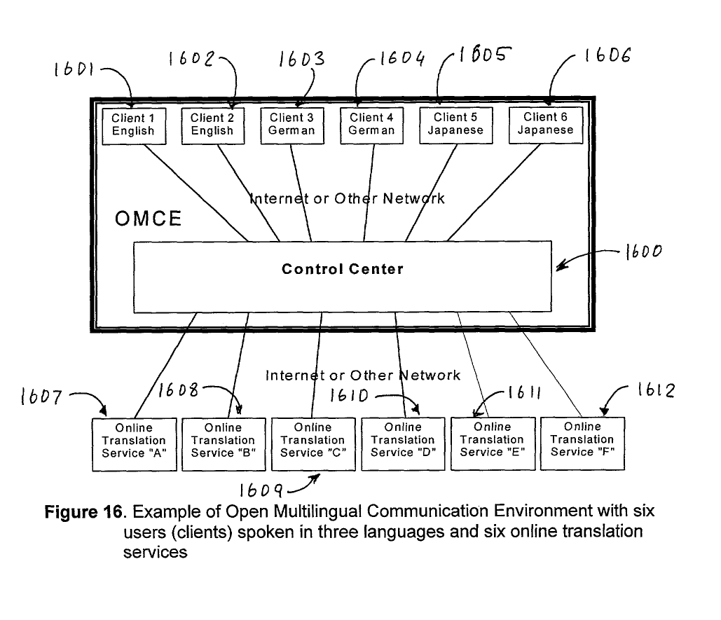

FIG. 15 shows an example of the implementation of the translation services selection for a given <theme, language 1, language 2>combination by the best rating among matching translation services. The diagram shows that “Translation Service 2” 1501 is ranked the best for English-German translation for “General” theme with rating equal to 4. The next service by rating is “Translation Service 1” 1502 for English-German translation on “General” theme with rating equal to 2. In case of failure of “Translation Service 2”, it will be replaced with “Translation Service 1”.

The translation engines are managed by the Control Center to provide the best translation for every translation, language pair, and translation theme. Generally speaking, Control Center is a self-learning system that runs real-time quality rating of the engaged translation engines and selects the best suitable engine for the translation session or translation request. In case of failure or unavailability of the needed translation engine, the Control Center automatically switches to the next engine selecting a translation engine with highest rating.

Self-learning dictionaries or thesauruses automatically collect the appropriate terms from their usage for a specific theme in general or for specified sessions. Static dictionaries or thesauruses are populated from the existing dictionaries or thesauruses, which could also come from a third party. The terms, which are not properly translated by the engaged online translation service (or services), are replaced with the proper terms for translation correction during the communication session. The following example illustrates a possible mechanism how the automatic self-learning dictionary or thesaurus works: in a communication session on “Computer” theme a sending party wrote the following phrase in English “We need a fast computer bus”. The translation service translates into Russian HaM Tpe6yeTcq 6b[CTpbIM KOMnblOTepHbiV aBTo6yc” (Reverse translation into English: “We need a fast commuter bus”, where term “bus” is translated as “commuter vehicle”). This confusion is caused by the fact that term “bus” has two different translations into Russian depend on the meaning. The recipient party either corrects the term or asks a question “Bbl MMeeTe B BMAy KOMnbloTePHYiO WL4Hy” (Reverse translation into English: “Do you mean a computer bus?” As soon as the term is corrected by the recipient party or upon receipt of the confirmation from the sending party, the dictionary stores the correct translation of the term to be used for the “computer” theme. Every term in the dictionary or thesaurus may have its matching rating that indicates the closeness of the translated term into the original term. Such rating can be used in case of one-to-many possible translations of a term into another language. Static auxiliary dictionaries or thesauruses can be taken from third parties or created from scratch. The third party dictionaries or thesauruses can be downloaded, or installed or, used as an online service.

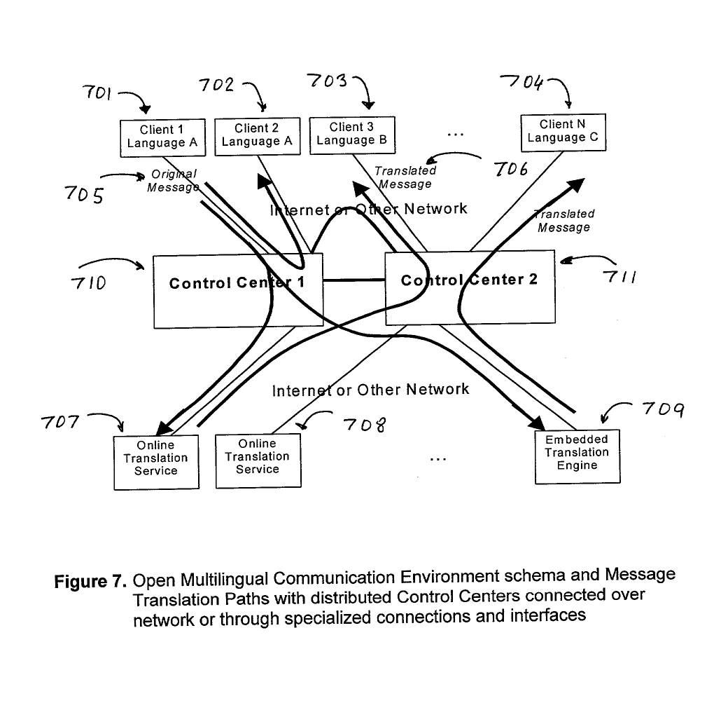

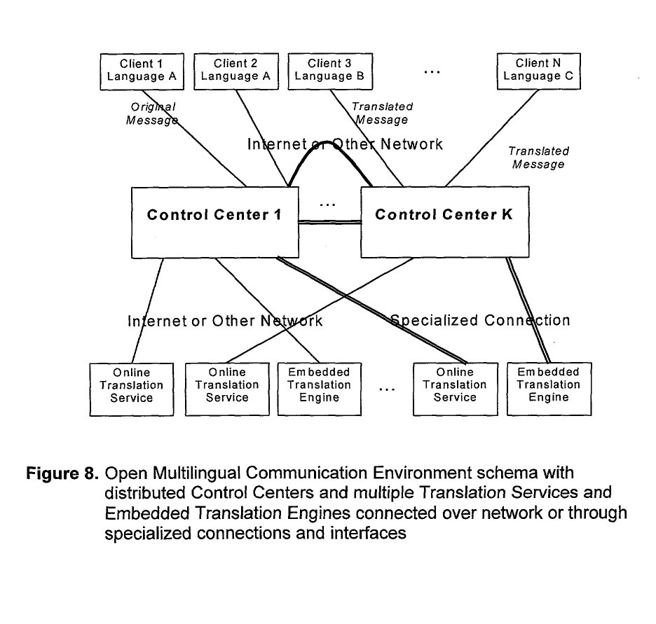

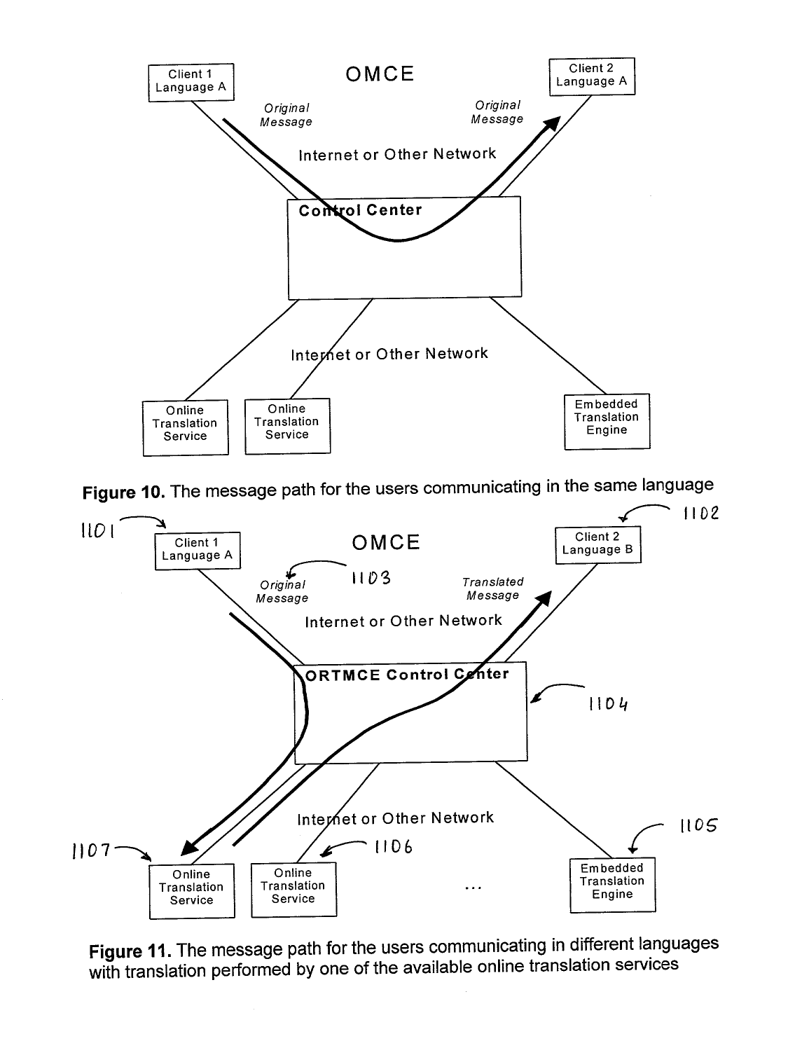

In a case of text based communication an original message 705 or 1003 (FIG. 7 and FIG. 10) from the sending party is directly forwarded to all recipients using the same language. If the recipient parties need translation into the languages different from the language of the sending party, the message is forwarded to the selected translation services 707, 1107 that provide translation into the languages of the recipients using languages different from the language of the sending party as shown in FIG. 7 and FIG. 11.

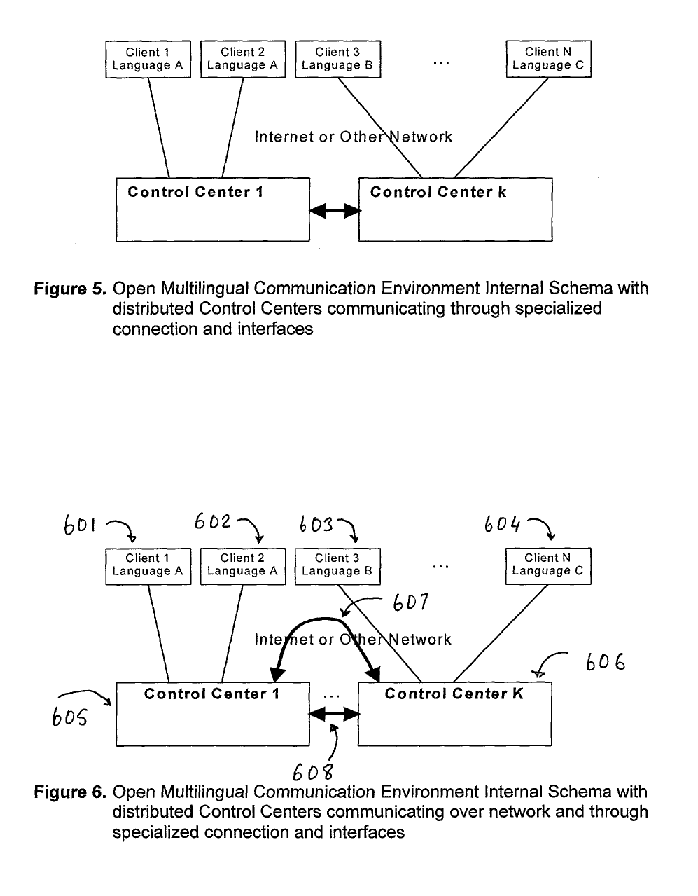

Different translation services can be utilized for a translation of the same message into different languages and a quality rating for each particular pair of languages and communication theme can be done independently. The translation services availability on the network is managed by a Control Center 210, see FIG. 2 or distributed Control Centers 710, 71 1, see FIG. 7. The translated messages are forwarded to the appropriate recipients. Several examples of the possible communication schemes between distributed Control Centers are shown on FIG. 4, FIG. 5, and FIG. 6.

In case of voice communication, a message from a sending party is directly forwarded to the recipients spoken the same language and forwarded to the selected translation services for translation into the languages of the other recipients spoken languages different from the language of the sending party. As in a case of text-based communication, different translation services can be utilized for a translation of the same message into different languages and a quality rating for each particular pair of languages and communication theme can be done independently. The translation services availability on the network is managed by a Control Center 210, see FIG. 2 or distributed Control Centers 710, 711, see FIG. 7.

The translated messages are forwarded to the appropriate recipients. If a voice translation service is available and selected for the translation for the particular ordered pair of languages and the communication theme, the voice message is translated by the selected voice translation service and then forwarded to the recipient. In a text-based translation service is selected and available for the translation for the particular ordered pair of languages and the communication theme, the voice message is converted to text by voice recognition module 1302, see FIG. 13 and then forwarded to the selected text-based translation service. The translated text-based message is then converted to voice by a voice generation module 1303 and forwarded to the appropriate recipient or recipients.

A combination of the text-based and voice communication works as a combination of text-based and voiced-based methods described previously.

The implementation of the invention makes users be able to communicate in text-based and/or voice modes on an international level without language barriers. The best quality real-time online translation services are used for translation from each language into another language for every particular communication theme. The communication environment system is self-learning from experience as of usage of the best translation services for particular languages and particular communication themes. The built-in auxiliary dictionaries serve to improve the communication quality for the particular communication themes. Each participant of the communication session no longer needs to understand the language in which the conversation is held. A user can select his or her own language and communicate with the other participants of the communication session as though he or she is fluent in the conversation language. Also, the language translation is performed in a real-time or close to a real-time such a way that the user requiring translation is not hindered. The multi-lingual communication session is no longer dependent on any particular translation service or translation engine and dynamically supports the best possible translation quality.

FIG. 16 illustrates a communication initiated and sustained online session between English-speaking clients 1601, 1602, Japanese-speaking client 1606, and German-speaking clients 1603, 1604 logged onto the online service, which supports such multilingual communication. A communication theme is selected for example as finance. Online translation service “A” 1607 is selected as the best available translation service for translation from English into Japanese and Japanese into English for the finance theme. Online translation service “B” 1608 is selected as the best translation service for translation from German into Japanese and Japanese into German for the same theme. Online translation service “C” 1609 is selected as the best available translation service for translation from English into German while online translation service “D” 1610 is selected as the best available for translation from German into English for the finance theme. All these translation services “A”, “B”, “C”, and “D” are engaged into the communication session. Some participants set up a preference to see messages only in their spoken languages while other participants set up the option to see messages in both, the massage original language and their spoken language. An English-speaking participant sends a message in English. The original message in English is being directly forwarded to all other English-speaking participants and to all other participants who prefer to see all messages in the original language too. At the same time, the original message in English is being forwarded to translation services “A” 1607 and “C” 1609 for translation accordingly into Japanese and German. The Japanese translation is then being forwarded to all participants speaking Japanese and the German translation of the message is being forwarded to all German-speaking participants. Thus some participants view the messages only in their spoken languages as well as other participants view the messages in the language the message was originally sent as well in translation into the session participants' spoken languages. At certain moment during the communication session, the online translations service “A” 1607 failed or become unavailable due to some circumstances. The failed or unavailable translation service “A” 1607 was replaced by some other available online translation service “E” 1611 that supports English-Japanese translations for the same theme. As a result, the communication session was not interrupted. In the meantime, online translation service “E” 1611 provided a good quality of translation and its rating has been raised while the rating of online translation service “A” 1607 decrease due to the failure. It occurs that now the rating of online translation service “E” 1611 became higher than the rating of the online translation service “A” 1607 for English-Japanese translation in finance area. This gives the online translation service “E” 1611 a priority to be selected for next communication session as the best translation service for English-Japanese translation for “finance” theme.

The invention employs various computer-implemented operations on data stored in computer systems. These operations are requiring physical manipulation of physical quantities. Usually, though not necessarily, these quantities take a form of electrical or magnetic signals capable of being stored, transferred, combined, compared, and otherwise manipulated. Further, the manipulations performed are often referred to in terms, such as producing, identifying, determining, or comparing. An apparatus may be specially designed for these purposes, or it may be a general purpose computer selectively activated or configured by a computer program stored in the computer. In particular, various general purpose computer systems may be used with computer programs written in accordance with the teachings herein, or it may be more convenient to construct a more specialized apparatus to perform the required operations. Block diagrams of exemplary embodiments of the Control Center are shown on FIG. 12 and FIG. 13.

What is claimed is:

1. A computer-implemented method of multilingual communication over Internet or other computer based networks, said method comprising the steps of:
1) configuring a multilingual and multi-user environment to provide a real-time natural language translation including the steps of:
a) initializing a directory of available translation services;
b) initializing a data base of clients preferences;
c) initializing available embedded real-time translation services;
d) initializing available specialized dictionaries and thesauruses;
e) identifying new translation services available on network and including them in a directory of available translation services;
2) receiving a request from at least one client to start a communication session and to establish a contact with the multilingual and multi-user environment;
3) identifying from the client's individual preferences or the client's request a client's language;
4) identifying from the client's request at least one recipient of communications and a corresponding recipient's language;
5) establishing a connection between the multilingual and multi-user environment and at least one translation service or embedded translation engine from the client's language to recipients' language, said service or engine have a highest rating in the directory of translation services;
6) receiving from the client a communication required the translation;
7) sending the client's communication to the connected translation service or the embedded translation engine with the highest rating;
8) receiving a translated client's communication from the connected translation service or the embedded translation engine;
9) providing recipients in real time with the translated client's communication.

2. A computer-implemented method of multilingual communication over Internet or other computer based networks of claim 1 further comprising a step of dynamically updating a list of available on-line translation services.

3. A computer-implemented method of multilingual communication over Internet or other computer based networks of claim 1 further comprising a step of an automatic adjustment of a translation rating.

4. A computer-implemented method of multilingual communication over Internet or other computer based networks of claim 1 further comprising a step of forwarding the client's communication to the recipient without the translation if the client's language and the recipient's language are identical.

5. A computer-implemented method of multilingual communication over Internet or other computer based networks of claim 1 further comprising a step of dynamically adding clients to the communication session and removing clients from the communication session.

6. A computer-implemented method of multilingual communication over Internet or other computer based networks of claim 1 further comprising a step of identifying an identity of client(s) and/or recipient(s) before granting an authorization to start the communication session and to establish the contact with the multilingual and multi-user environment.

7. A computer-implemented method of multilingual communication over Internet or other computer based networks of claim 1 further comprising a step of marking up a part of the client's communication to be delivered to all recipients in the client's language without the translation.

8. A computer-implemented method of multilingual communication over Internet or other computer based networks of claim 1 wherein the communication session is a text based communication session.

9. A computer-implemented method of multilingual communication over Internet or other computer based networks of claim 1 wherein the communication session is a voiced based communication session.

10. A computer-implemented method of multilingual communication over Internet or other computer based networks of claim 1 where in the communication session includes text based and voice based communications.

11. A multilingual network based translation system comprising:
1) a control center, said control center including:
a) a communication session control module;
b) a language translation management module;
c) a client profile management module;
d) a translation service rating module;
e) a translation correction module;
f) a directory of translation services management module;
2) at least one embedded translation engine;
3) at least one communication interface to communicate with at least one client and at least one recipient.

12. A multilingual network based translation system according to claim 11 further comprising: a voice-to-text converter module and a text-to-voice converter module.

13. A multilingual network based translation system according to claim 11 further comprising:
an access authorization module responsible for issuing a permission to a client
and/or recipient to start a communication with the multilingual network based translation system.

14. A multilingual network based translation system according to claim 11 wherein the translation service rating module is adjusting a rating of the translation service according to a quality of the translation, an availability of the translation service, or other characteristics

15. A multilingual network based translation system according to claim 11 wherein the client profile management module is dynamically maintaining a status of client's preferences.

16. A multilingual network based translation system according to claim 11 wherein the translation correction module is dynamically updating specialized dictionaries and thesauruses.

17. A multilingual network based translation system according to claim 11 wherein the translation service module is automatically maintaining the rating of engaged translation services.
